(19) United States
(12) Patent Application Publication
(10) Pub. No.: US 2022/0391789 A1
(43) Pub. Date: Dec. 8, 2022

(54) DYNAMICALLY DISENGAGING A LOCK MECHANISM FOR A HARDWARE SERVICE EVENT

(71) Applicant: International Business Machines Corporation, Armonk, NY (US)

(72) Inventor: Samuel Patterson, Shrewsbury, MA (US)

(21) Appl. No.: 17/339,102

(22) Filed: Jun. 4, 2021

(51) Int. Cl. G06Q 10/06; G07C 9/00; G06Q 10/00

(52) U.S. Cl. CPC G06Q 10/0631; G07C 9/00182; G06Q 10/20

(57) ABSTRACT

A system for access control is provided. A computing device schedules a hardware service event for a hardware component, the hardware component locked in a physically locked position by a locking mechanism of a hardware lock. The computing device, at a time corresponding to the hardware service event, authorizes a service technician to access the hardware component. The computing device instructs the hardware lock to disengage the locking mechanism based, at least in part, on the authorizing of the service technician. The computing device determines that an end condition for the hardware service event has been met. The computing device terminates the hardware service event based, at least in part, on the determining that the end condition for the hardware service event has been met.

### BACKGROUND OF THE INVENTION

The present invention relates generally to the field of security systems and more particularly to a software-controlled hardware lock that provides access control for a hardware component.

Hot-swapping generally relates to the replacement or addition of components of a computer system without stopping, shutting down, or rebooting the computer system. In general, hot-swapping is desirable to change the configuration of or to repair a working system without interruption to its operation.

### SUMMARY

Embodiments of the present invention provide a method, system, and program product. In an embodiment, a computing device schedules a hardware service event for a hardware component, the hardware component locked in a physically locked position by a locking mechanism of a hardware lock. The computing device, at a time corresponding to the hardware service event, authorizes a service technician to access the hardware component. The computing device instructs the hardware lock to disengage the locking mechanism based, at least in part, on the authorizing of the service technician. The computing device determines that an end condition for the hardware service event has been met. The computing device terminates the hardware service event based, at least in part, on the determining that the end condition for the hardware service event has been met.

### BRIEF DESCRIPTION OF THE SEVERAL VIEWS OF THE DRAWINGS

FIG. 1 is a functional block diagram illustrating a computing environment, in which a computing device determines to unlock a hardware-controlled lock mechanism, in accordance with an exemplary embodiment of the present invention.

FIG. 2 illustrates operational processes of executing a system for determining to unlock a hardware component during a hardware service event, on a computing device within the environment of FIG. 1, in accordance with an exemplary embodiment of the present invention.

FIG. 3 depicts a first visual representation of a hardware component in a locked state within a drive carrier, according to at least one embodiment of the present invention.

FIG. 4 depicts a second visual representation of a hardware component in a locked state within a drive carrier, according to at least one embodiment of the present invention.

FIG. 5 depicts a third visual representation of a hardware component in a locked state that includes a frontal visual representation of the drive carrier, according to at least one embodiment of the present invention.

FIG. 6 depicts a cloud computing environment, according to at least one embodiment of the present invention.

FIG. 7 depicts abstraction model layers, according to at least on embodiment of the present invention.

FIG. 8 depicts a block diagram of components of one or more computing devices within the computing environment depicted in FIG. 1, in accordance with an exemplary embodiment of the present invention.

### DETAILED DESCRIPTION

Detailed embodiments of the present invention are disclosed herein with reference to the accompanying drawings. It is to be understood that the disclosed embodiments are merely illustrative of potential embodiments of the present invention and may take various forms. In addition, each of the examples given in connection with the various embodiments is intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the present invention provide access control for a hardware component in a secure computing environment. Embodiments of the present invention further provide that a system administrator may control access to the computing environment based, at least in part, on a policy-driven process that determines when service personnel are permitted and/or required to respond to a hardware service event within the secure computing environment. Generally speaking, the hardware service event may represent a period of time following a failure or malfunction of a computer device and/or computer equipment within the secure computing environment, during which the failed or malfunctioned computer device and/or computer equipment is to be repaired and/or serviced.

Embodiments of the present invention provide that service personnel represent individuals who are typically employed by a business or corporation that own and/or operate the secure computing environment. The individuals are generally trained technicians that are capable of repairing and/or servicing, for example, a failed computer drive within the secure computing environment, by removing the failed computer drive and replacing the failed computer drive with a new hot-swappable computer drive. Alternatively, various embodiments of the present invention provide that the service personnel (or service technicians) may include automated robotics that are capable of operating within the secure computing environment and further repair and/or service the failed drive. The automated robotics may, for example, remove the failed computer drive from the drive carrier during the hardware service event similar to how an individual would remove the failed computer drive and replace the failed computer drive with a new hot-swappable computer drive.

Embodiments of the present invention provide technological improvements over known hardware-based security systems by providing software-based policies that control access to hardware components beyond simple mechanical locks. For example, while mechanically-latched hardware bays, such as drive bays, are secured by mechanical locking mechanisms, they are generally operated manually and without enhanced security. Various embodiments of the present invention provide for a software-based lock mechanism, communicatively connected to a hardware lock mounted adjacent to a drive bay that secures a hardware component stored in the drive bay, that adds additional security beyond the security provided by purely mechanical locks. Further, various embodiments of the present invention allow a system administrator, or system operator, to control who has access to the hardware component and when the hardware component may be removed from the system. In this way, various embodiments of the present invention provide an efficient and secure system to reduce damage and/or malicious theft of data related to the hardware components.

The present invention will now be described in detail with reference to the Figures.

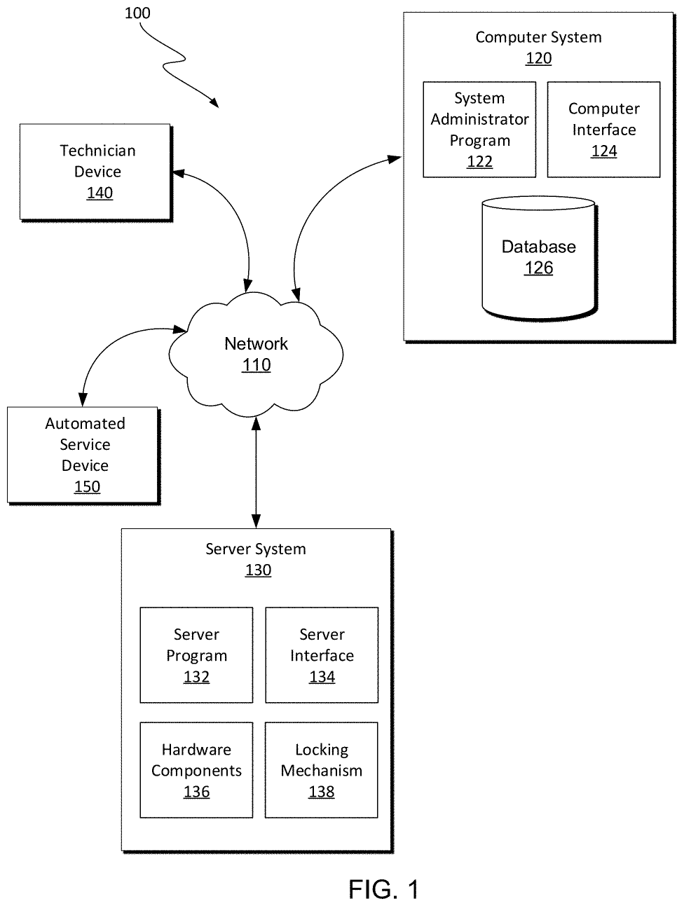

FIG. 1 is a functional block diagram illustrating computing environment, generally designated 100, in accordance with one embodiment of the present invention. Computing environment 100 includes computer system 120, server system 130, technician device 140, and automated service device 150 connected over network 110. Computer system 120 includes system administrator program 122, computer interface 124, and database 126. Server system 130 includes server program 132, server interface 134, hardware components 136, and locking mechanism 138.

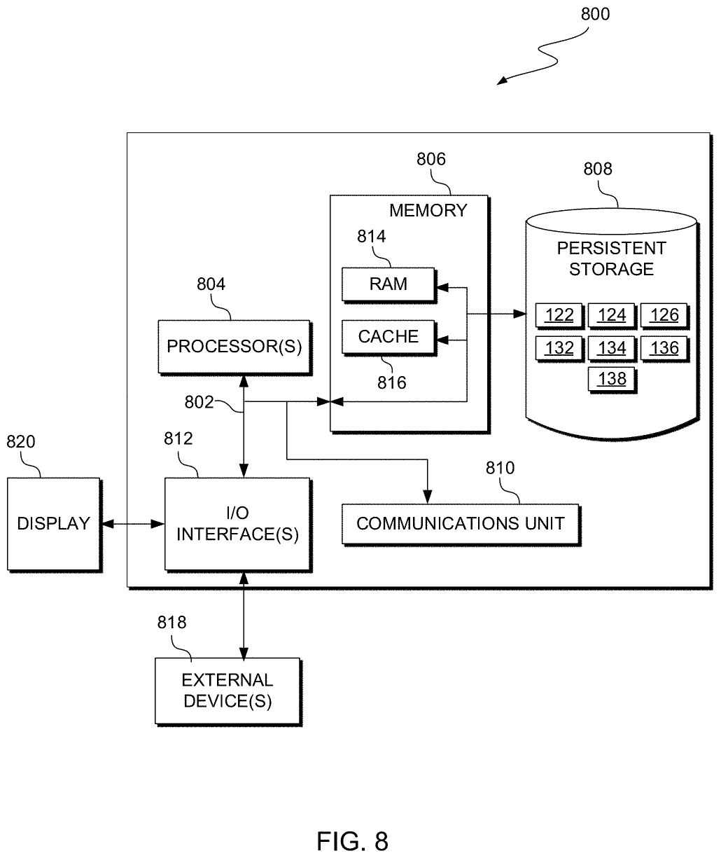

In various embodiment of the present invention, computer system 120 is a computing device that can be a standalone device, a server, a laptop computer, a tablet computer, a netbook computer, a personal computer (PC), a personal digital assistant (PDA), a desktop computer, or any programmable electronic device capable of receiving, sending, and processing data. In general, computer system 120 represents any programmable electronic device or combination of programmable electronic devices capable of executing machine readable program instructions and communications with various other computer systems (not shown). In another embodiment, computer system 120 represents a computing system utilizing clustered computers and components to act as a single pool of seamless resources. In general, computer system 120 can be any computing device or a combination of devices with access to various other computing systems (not shown) and is capable of executing system administrator program 122 and computer interface 124. Computer system 120 may include internal and external hardware components, as described in further detail with respect to FIG. 8.

In this exemplary embodiment, system administrator program 122 and computer interface 124 are stored on computer system 120. However, in other embodiments, system administrator program 122 and computer interface 124 are stored externally and accessed through a communication network, such as network 110. Network 110 can be, for example, a local area network (LAN), a wide area network (WAN) such as the Internet, or a combination of the two, and may include wired, wireless, fiber optic or any other connection known in the art. In general, network 110 can be any combination of connections and protocols that will support communications between computer system 120, server system 130, technician device 140, and automated service device 150, and various other computer systems (not shown), in accordance with desired embodiments of the present invention.

In the embodiment depicted in FIG. 1, system administrator program 122, at least in part, has access to server program 132, hardware components 136, and locking mechanism 138 and can communicate data stored on computer system 120 to server system 130, technician device 140, automated service device 150, and various other computer systems (not shown). More specifically, system administrator program 122 defines a user of computer system 120 that has access to data stored on server system 130 and/or database 126.

System administrator program 122 is depicted in FIG. 1 for illustrative simplicity. In various embodiments of the present invention, system administrator program 122 represents logical operations executing on computer system 120, where computer interface 124 manages the ability to view these logical operations that are managed and executed in accordance with system administrator program 122. In some embodiments, system administrator program 122 represents a system that processes and analyzes data to remotely unlock (or disengage) a software-controlled hardware lock (e.g., locking mechanism 138) associated with, at least, a hardware service event. In various embodiments of the present invention, system administrator program 122 represents a program via which an individual makes decisions (e.g., policy-based decisions) regarding when to initiate a hardware service event for a failed drive (e.g., hardware components 136) within the computing environment to be serviced by an authorized service technician. Alternatively, in various embodiments of the present invention, system administrator program 122 represents a software program that includes, at least, a set of policy-based commands that make decisions regarding when a hardware service event should be initiated for a failed drive (e.g., hardware components 136) within the computing environment.

Various embodiments of the present invention provide for a set of policy-driven decisions. In various embodiments, system administrator program 122 determines a set of policies that include, but not limited not, (i) authorizing a service technician prior to the service technician arriving at the secured computing environment, (ii) authenticating a service technician upon arrival at the secured computing environment and disengaging locking mechanism 138 associated with the failed hardware components 136, and (iii) disengaging locking mechanism 138 prior to the service technician's arrival at the secured computing environment and authenticating the service technician when the service technician arrives at the secured computing environment. Various embodiments of the present invention provide for additional policies that include, for example: (i) administrator program 122 requiring on-site authentication from a service technician and/or automated service device 150, wherein the on-site authentication includes fingerprint, touchpad, RFID, WIFI hotspot with password, and/or retinal scan, and wherein administrator program 122 instructs locking mechanism 138 to unlock (or disengage) based, at least in part, on the on-site authentication; (ii) administrator program 122 requiring multi-factor authentication, where administrator program 122 must perform the authentication and generate a unique electronic certificate that is assigned to a service account, and an individual who is an administrator must travel to the physical location to the secured environment and deploy the electronica certificate via a portable device (e.g., technician device 140) to authenticate and trigger the hardware service event; and (iii) administrator program 122 communicating with a plurality of automated service devices 150 directly and selecting at least one of the automated service device 150 based, at least in part, on data that resides on database 126 that includes: automated service device 150 capabilities, schedules, and current activities related to the one or more automated service devices 150. Various embodiments of the present invention provide that administrator program 122 generates a set of program instructions instructing the at least one of the plurality of automated service devices 150 to perform a set of actions to authenticate before and/or at the secured environment to trigger the hardware service event and repair and/or service the items and/or objects within the secured environment. Additionally, administrator program 122 communicates a set of program instructions instructing the at least one automated service device 150 to communicate a confirmation or denial relating to the set of program instructions to perform a set of actions. Various embodiments of the present invention provide that the hardware service event may be terminated after determining that an end condition for the hardware service event has been met. The end condition for the hardware service event may include, for example: (i) administrator program 122 identifying data indicating that hardware components 136 have been reintroduced to the drive carrier and/or a replacement hardware component has been introduced into the drive carrier, and administrator program 122 communicating a set of program instructions to locking mechanism 138 to lock the reintroduced hardware components 136 into the drive carrier (i.e., by reengaging the locking mechanism); (ii) administrator program 122 detecting that locking mechanism 138 has been manually reengaged; (iii) administrator program 122 determining that an amount of time for the hardware service event has elapsed; and (iv) administrator program 122 or a service technician with access privileges (e.g., certificates, passwords, tags, bio-markers) manually terminating the hardware service event.

Computer system 120 includes computer interface 124. Computer interface 124 provides an interface between computer system 120, server system 130, and technician device 140. In some embodiments, computer interface 124 can be a graphical user interface (GUI) or a web user interface (WUI) and can display, text, documents, web browsers, windows, user options, application interfaces, and instructions for operation, and includes the information (such as graphic, text, and sound) that a program presents to a user and the control sequences the user employs to control the program. In some embodiments, computer system 120 accesses data communicated from server system 130 and/or technician device 140 via a client-based application that runs on computer system 120. For example, computer system 120 includes mobile application software that provides an interface between computer system 120, server system 130, technician device 140, and automated service device 150. In various embodiments, computer system 120 communicates the GUI or WUI to server system 130 for instruction and use by a user of server system 130.

In various embodiments, server system 130 is a computing device that can be a standalone device, a server, server-cluster, web-servers, database and storage devices, a laptop computer, a tablet computer, a netbook computer, a personal computer (PC), a desktop computer, or any programmable electronic device capable of receiving, sending and processing data. In general, server system 130 represents any programmable electronic device or combination of programmable electronic devices capable of executing machine readable program instructions and communications with various other computer systems (not shown). In another embodiment, server system 130 represents a computing system utilizing clustered computers and components to act as a single pool of seamless resources. In general, server system 130 can be any computing device or a combination of devices with access to various other computing systems (not shown) and is capable of executing server program 132, server interface 134, hardware components 136, and locking mechanism 138. Server system 130 may include internal and external hardware components, as described in further detail with respect to FIG. 8.

Server program 132 is depicted in FIG. 1 for illustrative simplicity. In various embodiments of the present invention server program 132 represents logical operations executing on server system 130, where server interface 134 manages the ability to view these various embodiments, and server program 132 defines an administrator of server system 130 that has access to data stored on server system 130.

Technician device 140 is a computing device that can be a standalone device, a laptop computer, a tablet computer, a netbook computer, a personal computer (PC), a radio-frequency identification (RFID) device, or any programmable electronic device capable of receiving, sending and processing data that would provide authorization for a service technician to access the secure computing environment. In various embodiments, technician device 140 further represents a device that is capable of providing authorization to a service technician, where technician device 140 is authorized by an administrator (e.g., via system administrator program 122) prior to the service technician responding to a hardware service event within the secure computing environment. In various embodiments, system administrator program 122 authorizes technician device 140 based, at least in part, on the identification of a service technician (e.g., an employee for the administrator that has a verifiable employment agreement and/or identification card authorized by the administrator to allow access to various secure environments). In various embodiments, server system 130 represents a computing environment which technician device 140 provides the service technician access to. For example, system administrator program 122 generates an access control permission policy that allows technician device 140 to provide the service technician access to server system 130 during a hardware service event.

Automated service device 150 is a computing device that can be an automated robotic arm affixed to a track in the floor, an artificial intelligence computing device that is capable of automatically maneuvering through the secured computing environment, and any programmable computing electronic device capable of receiving and processing data that would provide for automated service device 150 to automatically and independently repair and/or service failed hardware components 136 executing on server system 130.

Additionally, in some embodiments, computer system 120 server system 130, technician device 140, and automated service device 150 represent, or are part of, a cloud computing platform. Cloud computing is a model or service delivery for enabling convenient, on demand network access to a shared pool of configurable computing resources (e.g., networks, network bandwidth, servers, processing, memory, storage, applications, virtual machines, and service(s) that can be rapidly provisioned and released with minimal management effort or interaction with a provider of a service). A cloud model may include characteristics such as on-demand self-service, broad network access, resource pooling, rapid elasticity, and measured service, can be represented by service models including a platform as a service (PaaS) model, an infrastructure as a service (IaaS) model, and a software as a service (SaaS) model, and can be implemented as various deployment models as a private cloud, a community cloud, a public cloud, and a hybrid cloud. In various embodiments, server system 130 represents a database or website that includes, but is not limited to, data associated with rule-based access control via a software-controlled hardware lock.

Computer system 120 and server system 130 are depicted in FIG. 1 for illustrative simplicity. However, it is to be understood that, in various embodiments, computer system 120 and server system 130 can include any number of databases that are managed in accordance with the functionality of system administrator program 122. In general, database 126 represents data and system administrator program 122 represents code that provides an ability to use and modify the data. To illustrate various aspects of the present invention, examples of system administrator program 122 represents one or more of, but is not limited to, policies that determine access control to hardware components 136 stored on server system 130.

Various embodiments of the present invention provide for a secured computing environment that includes, but is not limited to, server system 130. Alternatively, various embodiments of the present invention provide for administrator program 122 to control access to various other secured environments that includes, but not limited to, serviceable and/or accessible hardware that further includes: a warehouse with merchandise on racks and/or shelving units, determining which service technicians or automated service devices access for regular operations, an international and/or long-hauler cargo ship that controls access to which shipping containers are to be assigned to be delivered to a given port, a shelving unit that contains merchandise available for purchase to the public, and a locked mailbox and/or mail carrier facility with unlockable doors/grates that contain personalized mail within each respective row and/or shelving unit.

Embodiments of the present invention recognize that computing and/or storage equipment often includes accessible drive bays for standard hard drives or solid-state drives to enable them to be hot-swappable for ease of drive replacement. Often, these drives are placed and/or supported by drive carriers that are capable of being slid into and out of the drive bays, additionally, the drive carriers are fixed into place manually by a mechanical latch. In various embodiments, hot-swappable drives are generally used to store data for use by software programs. In general, the drives are susceptible to failing and may require replacement. Because software programs generally need to be highly available for end-users, it is desirable for the drives to be hot-swappable, where the software running on the system has little to no downtime during a service event.

In various embodiments, a highly available computing or storage system utilizes a redundant array of inexpensive disks (RAID). In various embodiments, different RAID levels allow for various threshold levels of fault tolerance. In one example, RAID 6 consists of a block-level stripping with double distributed parity, where the double distributed parity allows for two separate drives to fail per array. In various embodiments, at any RAID level the risk of data loss or corruption is ever present, if more than one drive that is connected to a RAID array fails or is removed. Various embodiments of the present invention recognize that if a drive fails it must be replaced before, at least, another drive fails too. Further, when service personnel arrive to replace the failed drive during a service event, it is not uncommon to unintentionally remove the incorrect drive; if a drive in a RAID 5 array has already failed, then removing the wrong drive can destroy or corrupt the data on the entire array.

Embodiments of the present invention provide that, irrespective of the use of RAID, removing a drive from a system without proper due diligence and system management can be the result of data corruption and/or lead to software downtime or instability in the system configuration. Further, the risk of a malicious individual removing a drive to access sensitive data stored on the drives is critical. Embodiments of the present invention provide for a software-controlled hardware lock that authorizes a specified service technician access to the drives during a defined hardware service event, thereby preventing theft of sensitive data. Additionally, in various embodiments of the present invention, approval by a system administrator would be required to communicate a set of program instructions to unlock (or disengage) the software-controlled hardware lock (e.g., locking mechanism 138) on the specified failed drive (e.g., hardware components 136).

Embodiments of the present invention provides for a server and/or storage equipment that includes, but is not limited to, a software-controllable mechanical latch (e.g., locking mechanism 138) for access control. In various embodiments, system administrator program 122, or a system operator of computing environment 100, controls who (e.g., service technician) has access to a computer drive (e.g., hardware components 136), and when (e.g., hardware service event). In various embodiments, system administrator program 122 further provides access by controlling when a service technician in possession of technician device 140 may remove the computer drive (e.g., hardware components 136) from server system 130. In various embodiments, the policy-based software-controlled security measure is based, at least in part, on a lightweight directory access control (LDAP), computer-network authentication protocol, or various other similar policy-based software-controlled security measures known in the art. Embodiments of the present invention provide for the mechanical latch to be affixed to a panel (e.g., a grate and/or door) for each respective drive bay within the drive carrier that may be unlocked. System administrator program 122 communicates the set of program instructions to unlock a specified mechanical latch associated with, at least, the failed drive to ensure that the service technician has access to the correct drive during the hardware service event. Unlocking the software-controlled specified mechanical latch provides an additional layer of security and further provides efficiency and accuracy in the drive being serviced by the service technician.

In various embodiments of the present invention the drive carrier that houses and/or supports the computer drive includes a software-controlled mechanical latch. The drive carrier includes an electrical connection that transverses the length of the drive carrier from the mechanical latch to the back-side of the drive carrier that sits opposite of the mechanical latch and the opening of the drive carrier. A housing unit is affixed to the back-side of the drive carrier that includes a contact device that provides a threshold level of precision electrical connection between the drive carrier's contact device and the housing unit. Embodiments of the present invention further provide that the housing unit includes, at least, a matching contact device that includes an electrical connection from the contact device to a processing device, where the processing device executes to control the state of the hardware-lock electrically via a software-togglable transistor. The software-toggleable transistor operates similarly to various other transistor-driven digital logic on a motherboard as known in the art. Software executing on the processing device includes a set of program instructions instructing the toggle of the hardware lock (e.g., locking/engaging and unlocking/disengaging) during and at the termination of a hardware service event as defined by system administrator program 122.

Various embodiments of the present invention provide that a policy-based administration is created to define the requirement to generate a hardware service event to repair and/or service a failed drive within the computing environment. The policy-based administration represents an asynchronous software-defined alert (e.g., an email alert and/or a graphical notification) received by system administrator program 122 to detect the need to generate a hardware service event. Alternatively, the policy-based administration represents system administrator program 122 detecting the need to generate a hardware service event based, at least in part, on the result of manual troubleshooting of server system 130.

In various embodiments of the present invention the hardware service event represents a repair and/or service related to a hardware device (e.g., hardware components 136) operating on server system 130. Additionally, in various embodiments, the hardware service event represents communicating an access control request with a set of program instructions instructing the software-controlled hardware lock to unlock and allow a service technician to remove the computer drive from its position within the drive carrier. The hardware service event further includes, but is not limited to, (i) removal of one or more hardware components 136 from their physically locked location within the drive carrier, (ii) electrical disconnection of the one or more hardware components 136 from server system 130, and (iii) hot-swapping one or more hardware components 136 for a new computer drive to be placed in the drive carrier of the removed one or more hardware components 136. Alternatively, in some embodiments, the hardware service event further includes re-seating an electrical or physical connection of hardware components 136 within the drive carrier and continuing to utilize the same computer drive (e.g., hardware components 136) without the requirement of replacing hardware components 136.

Various embodiments of the present invention provide that to maintain security regarding the safety of data residing on the one or more hardware components 136 executing on server system 130, that system administrator program 122 concurrently supervises the hardware service event. In various embodiments, service personnel are provided with a security measure that allows system administrator program 122 to authenticate service personnel that includes, but is not limited to, a password, physical or electronic key, and biometric authentication (e.g., verification of a user's identity through biological traits such as retinas, irises, vocal patterns, facial characteristics, and fingerprints). Additionally, service personnel can communicate and/or collaborate with a system administrator (e.g., an individual that oversees the operation of computer system 120) through the use of cellular communications and/or direct person-to-person interactions with the system administrator. Alternatively, hardware components 136 could be unlocked prior to the arrival of a service technician during the predefined time period of the hardware service event. Hardware components 136 are unlocked via a set of program instructions communicated by system administrator program 122 to unlock the software-controlled hardware lock (e.g., locking mechanism 138) electronically connected to the driver carrier of hardware components 136. Additionally, hardware components 136 can be locked (i.e., locking mechanism 138 can be reengaged) at the conclusion of the threshold period of time of the hardware service event or at a subsequent period of time after the termination of the hardware service event. System administrator program 122 communicates a set of program instructions to the software-controlled hardware lock (e.g., locking mechanism 138) electronically connected to the drive carrier of hardware components 136 to lock the hardware lock.

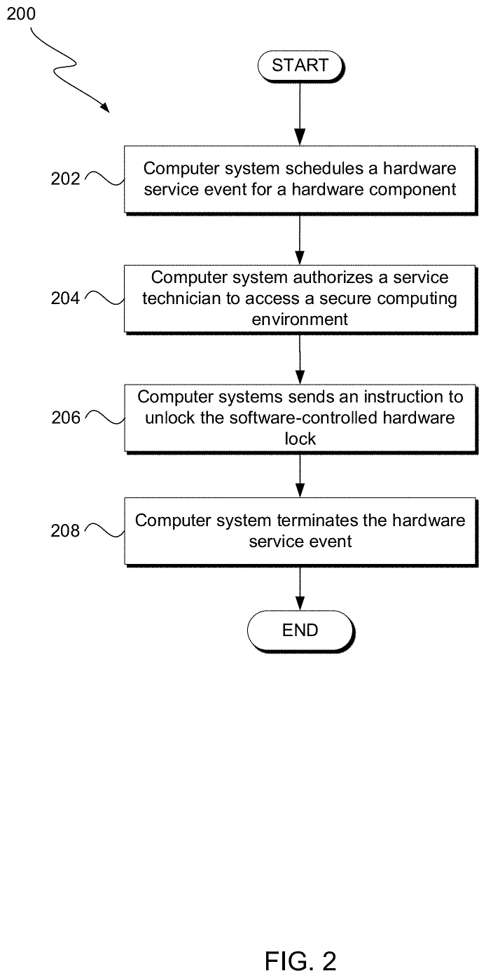

FIG. 2 is a flowchart, 200, depicting operations of system administrator program 122 in computing environment 100, in accordance with an illustrative embodiment of the present invention. FIG. 2 also represents certain interactions between system administrator program 122, server program 132, and technician device 140. In some embodiments, the operations depicted in FIG. 2 incorporate the output of certain logical operations of system administrator program 122 executing on computer system 120. It should be appreciated that FIG. 2 provides an illustration of one implementation and does not imply any limitations with regard to the environments in which different embodiments may be implemented. Many modifications to the depicted environment may be made. In one embodiment, the series of operations in FIG. 2 can be performed in any order. In another embodiment, the series of operations, depicted in FIG. 2, can be terminated at any operation. In addition to the features previously mentioned, any operations, depicted in FIG. 2, can be resumed at any time.

In operation 202, system administrator program 122 schedules a hardware service event for a hardware component. In various embodiments, system administrator program 122 actively monitors the activity of the hardware components (e.g., hardware components 136) executing on server system 130. Alternatively, in various embodiments, system administrator program 122 receives a hardware alert from server program 132 that identifies a failure condition indicating that hardware components 136 executing on server system 130 have failed or are likely to fail. In various embodiments, system administrator program 122 determines that a computer drive (e.g., hardware components 136) has failed on server system 130 and that the computer drive needs to be replaced within a threshold period of time to prevent data loss or corruption across the array. In response to system administrator program 122 determining that a drive has failed, system administrator program 122 schedules a hardware service event. Alternatively, system administrator program 122 receives an alert from server program 132 indicating that, at least, one hardware components 136 has failed on server system 130 and includes a set of program instructions instructing system administrator program 122 to schedule a hardware service event request. In various embodiments, system administrator program 122 schedules the hardware service event for a defined period of time (e.g., one hour, two hours, etc.). System administrator program 122 determines the period of time based, at least in part, on a threshold level of difficulty to replace the failed drive and the availability of service technicians. In one example embodiment, system administrator program 122 identifies that it would take thirty (30) minutes to replace the failed drive on server system 130 and that it would additionally take thirty (30) minutes for a service technician to arrive to replace the failed drive on server system 130. In this example embodiment, system administrator program 122 schedules the hardware service event for one hour beginning upon communicating a work order to technician device 140.

In various embodiments of the present invention, system administrator program 122 accesses data on database 126 that indicates one or more service technicians and/or automated service device 150 that are capable of repairing and/or servicing the failed hardware components 136 (e.g., failed computer drive) on server system 130 based, at least in part, on the level of difficulty. System administrator program 122 analyzes the data regarding the one or more service technicians and/or automated service device 150 and identifies, at least, one service technician and/or automated service device 150 that can be scheduled to repair and/or service a failed drive (e.g., hardware components 136) on server system 130 during the scheduled hardware service event. In various embodiments, system administrator program 122 communicates a work order with a set of program instructions instructing technician device 140 to inform the service technician and/or automated service device 150 to service and/or repair the failed drive during the hardware service event.

In operation 204, system administrator program 122 authorizes a service technician to access a secure computing environment. Various embodiments of the present invention provide based, at least in part, on system administrator program 122 identifying a service technician that represent individuals and/or automated robotics who are employed by a business or corporation that own and/or operate within computing environment 100. In various embodiments of the present invention a service technician and/or automated service device 150 is authorized by system administrator program 122 to provide access to a secured computing environment (e.g., server system 130). In various embodiments, technician device 140 represents a computing device in the possession of an authorized service technician and/or automated service device 150 represents an automated robotic that is authorized by system administrator program 122 to repair and/or service a failed drive (e.g., hardware components 136) within server system 130 during a hardware service event. System administrator program 122 stores the data associated with the authorized service technician and/or automated service device 150 on database 126, and further system administrator program 122 stores the authorization data for the service technician on technician device 140.

In operation 206, system administrator program 122 sends an instruction to unlock the software-controlled hardware lock. In various embodiments, system administrator program 122 generates a set of program instructions based, at least in part, on the scheduling of the hardware service event to unlock the software-controlled hardware lock (e.g., locking mechanism 138) associated with the failed hardware components 136 on server system 130. System administrator program 122 communicates the set of program instructions instructing server program 132 to unlock locking mechanism 138, wherein locking mechanism 138 restricts movement of hardware components 136. Alternatively, system administrator program 122 communicates a set of program instructions to locking mechanism 138 and system administrator program 122 directly toggles locking mechanism 138 to unlock. In various embodiments, system administrator program 122 communicates the set of program instructions to unlock locking mechanism 138 at a specified threshold of time. In some embodiments, system administrator program 122 communicates the set of program instructions at the start of the hardware service event. Alternatively, in various other embodiments, system administrator program 122 communicates the set of program instructions before the hardware service event is scheduled to begin so that locking mechanism 138 is unlocked and the failed drive (e.g., failed hardware components 136) is waiting for technician device 140 to arrive and repair and/or service the failed drive.

Various embodiments of the present invention provide that locking mechanism 138 unlocks upon the arrival of the service technician arriving at the secured computing environment. In various embodiments, the service technician is required to present authentication upon arrival at the secured computing environment, in order to be authorized to enter the secured computing environment. The service technician presents technician device 140 to a computing device that communicates with system administrator program 122 (e.g., the service technician presents an authorized badge that includes an RFID tag and is scanned, and the service technician's data is communicated to a system administrator). System administrator program 122 receives the data relating to technician device 140 and correlates the data with the authorized data stored on database 126. System administrator program 122 determines whether the data received from technician device 140 matches the authorized data on database 126, and if the data matches then system administrator program 122 communicates an authorization code that allows the service technician access to the secured computing environment, and further communicates a set of program instructions to locking mechanism 138 that unlocks the failed hardware components 136 from the drive bay to allow the service technician to service and/or repair the failed hardware components 136.

In operation 208, system administrator program 122 terminates the hardware service event. In various embodiments, system administrator program 122 terminates the hardware service event at the conclusion of the specified threshold amount of time required for the service technician and/or automated service device 150 to arrive at server system 130 and to complete the repair and/or service of the failed drive. Alternatively, system administrator program 122 terminates the hardware service event when locking mechanism 138 is placed back in the locked position. Various embodiments of the present invention provide relocking hardware components 136 with locking mechanism 138 prevents various methods of theft that includes: inserting a malicious hardware component into the drive carrier, removing hardware components 136 from the drive carrier, reading data off of hardware components 136 onto a separate malicious portable computing component. In various embodiments, if the repair and/or service of the failed drive is taking a threshold period of time longer than system administrator program 122 determined, then the termination of the hardware service event terminates at the reconnection of locking mechanism 138 in the locked position. In various embodiments, at the conclusion of the repair and/or service of the failed drive, the service technician and/or automated service device 150 is instructed by the work order received by system administrator program 122 to reconnect locking mechanism 138 and lock the new hardware components 136 in position. In various embodiments, system administrator program 122 receives a notification from server program 132 that locking mechanism 138 has been reconnected and that the new hardware components 136 is in the locked position. Alternatively, in various embodiments, system administrator program 122 communicates a set of program instructions to locking mechanism 138 to automatically reconnect the hardware lock locking the new hardware components 136 at the termination of the hardware service event. Embodiments of the present invention provide that the drive carrier includes, at least, computing and hydraulic devices, and mechanical stops electrically connected to an electric motor attached to the drive carrier, that are capable of automatically closing the dive carrier grate and locking, locking mechanism 138 based, at least in part, on the set program instructions.

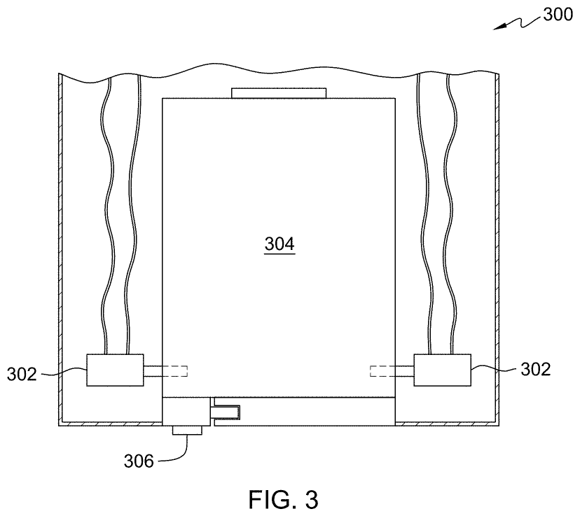

FIG. 3 depicts a first visual representation of a computer drive locked in position within a drive carrier (i.e., drive carrier 300) of a server stack. In various embodiments, a plurality of solenoid deadbolts 302 are mounted adjacent to drive receiver 304 and engage with the lateral sides of the computer drive to lock the computer drive into place at receiver 304. Solenoid deadbolt 302 represents a software-controlled hardware lock that is capable of receiving a set of program instructions to unlock solenoid deadbolt 302 to remove the computer drive from receiver 304 (i.e., a drive slot) of the drive carrier. An opening in the carrier slide of the computer drive provides an opening for solenoid deadbolt 302 to lock into. Additionally, the computer drive includes a release button 306 present on the front face of the computer drive to remove the computer drive from the drive carrier.

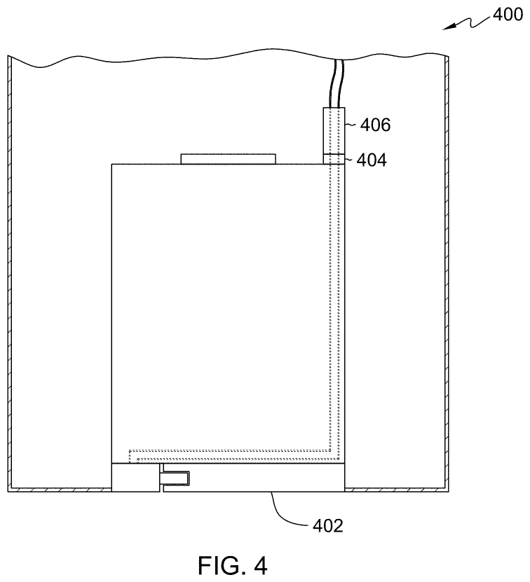

FIG. 4 depicts a second visual representation of a computer drive locked in position within a drive carrier (i.e., drive carrier 400) of a server stack. In various embodiments, solenoid deadbolt 402 resides adjacent the front of the computer drive and solenoid deadbolt 402 rests on a slide that moves back and forth from a lock (or engaged) position to an unlock (or disengaged) position. Solenoid deadbolt 402 represents a software-controlled hardware lock that is capable of receiving a set of program instructions to unlock solenoid deadbolt 402 to remove the computer drive from the drive slot of the driver carrier. In an alternative embodiment, solenoid deadbolt 402 includes a computing device that communicates, at least, with system administrator program 122 to receive a set of program instructions to execute the locking/unlocking of solenoid deadbolt 402, and solenoid deadbolt 402 is electrically connected to a power grid with ground connections to the drive carrier. In various embodiments, contact device 404 resides in a housing unit that is attached the back-side of the computer drive. Additionally, contact device 404 houses an electrical connection that connects housing device 406 to solenoid deadbolt 402. Contact device 404 is connected directly into the drive carrier and housing device 406 connects into contact device 404. Various embodiments of the present invention provide that the electrical connection provides for access control via the software-controlled hardware lock (e.g., solenoid deadbolt 402).

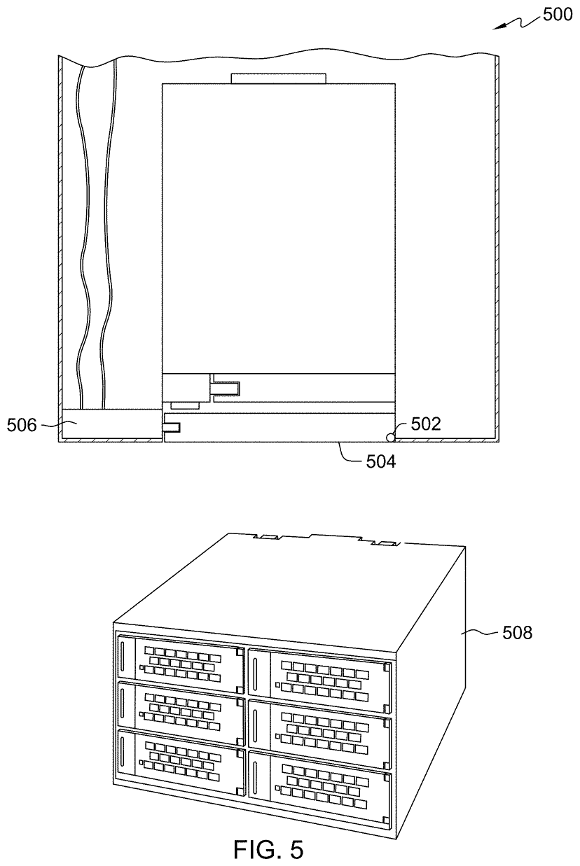

FIG. 5 depicts a third visual representation of a computer drive locked in a position within a drive carrier (i.e., drive carrier 500) of a server stack. FIG. 5 also provides a comparison view of a server stack (i.e., server stack 508). In various embodiments, hinge 502 is present on a singular side of the computer drive that is attached to the drive carrier and is further attached to grate 504. Grate 504 swivels along the axis of hinge 502 and opens to allow the computer drive to be removed once solenoid deadbolt 506 is unlocked. Solenoid deadbolt 506 represents a software-controlled hardware lock that is capable of receiving a set of program instructions to unlock solenoid deadbolt 506 to remove the computer drive from the drive slot of the drive carrier. In an alternative embodiment, solenoid deadbolt 506 includes a computing device that communicates, at least, with system administrator program 122 to receive a set of program instructions to execute the locking/unlocking of solenoid deadbolt 506, and solenoid deadbolt 506 is electrically connected to a power grid with ground connections to the drive carrier. Additionally, solenoid deadbolt 506 is connected by an electrical connection to receive the set of program instructions to unlock the software-controlled hardware lock (e.g., solenoid deadbolt 506). Various embodiments of the present invention provide that a plurality of grates 504 are present for each computer drive within the computer or storage enclosure containing one or more slots for drive carriers to be inserted, as depicted in server stack 508. Various embodiments of the present invention provide that the drive carrier is a housing unit for a singular drive. The drive carrier includes a set of slides along a guide rail within the computer or storage enclosure. Additionally, once hardware components 136 are placed within the drive carrier, the drive carrier can be reinserted into the computer or storage enclosure.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

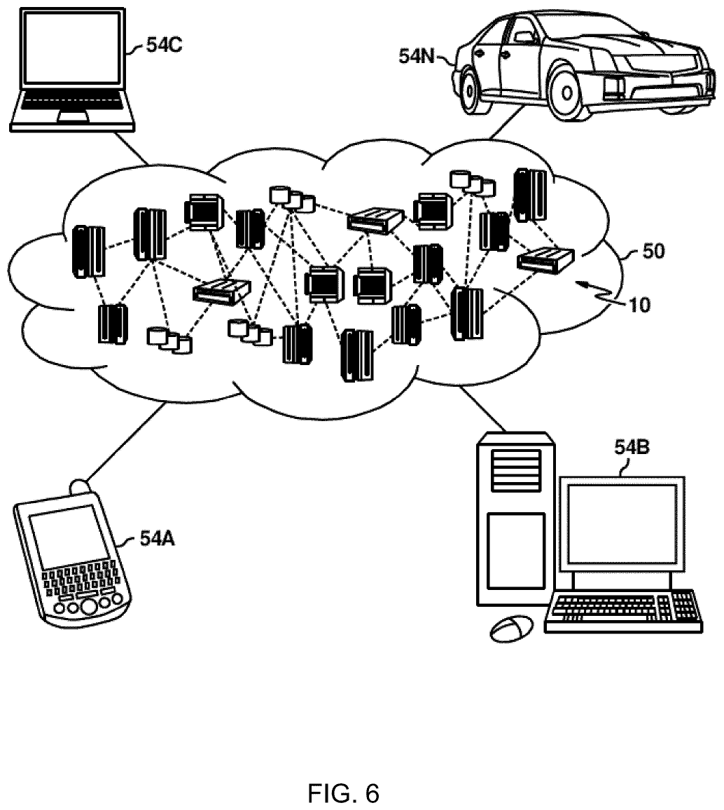

Referring now to FIG. 6, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

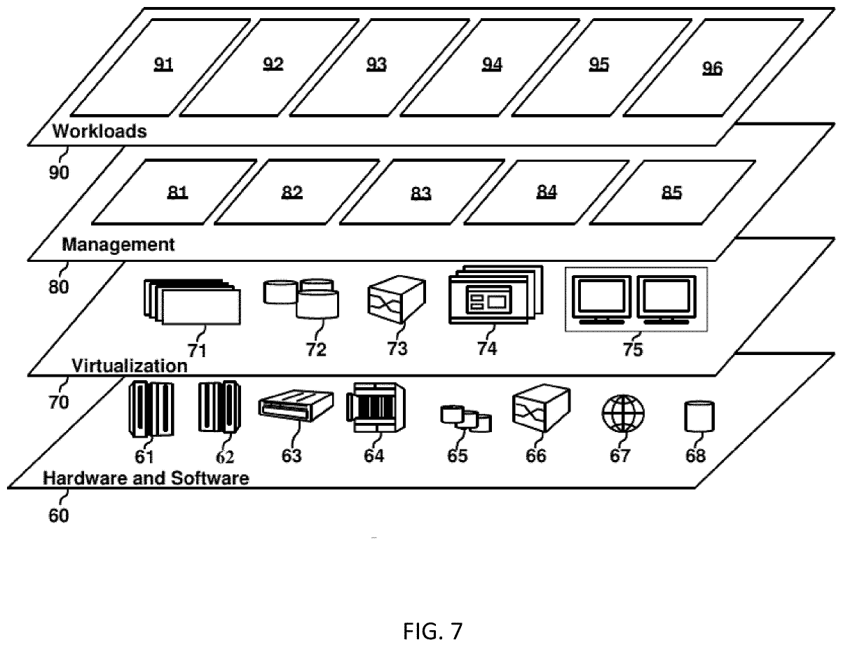

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and providing soothing output 96.

FIG. 8 depicts a block diagram, 800, of components of computer system 120, server system 130, technician device 140, and automate computing device 150 in accordance with an illustrative embodiment of the present invention. It should be appreciated that FIG. 8 provides only an illustration of one implementation and does not imply any limitations with regard to the environments in which different embodiments may be implemented. Many modifications to the depicted environment may be made.

Computer system 120, server system 130, technician device 140, and automated service device 150 includes communications fabric 802, which provides communications between computer processor(s) 804, memory 806, persistent storage 808, communications unit 810, and input/output (I/O) interface(s) 812. Communications fabric 802 can be implemented with any architecture designed for passing data and/or control information between processors (such as microprocessors, communications and network processors, etc.), system memory, peripheral devices, and any other hardware components within a system. For example, communications fabric 802 can be implemented with one or more buses.

Memory 806 and persistent storage 808 are computer-readable storage media. In this embodiment, memory 806 includes random access memory (RAM) 814 and cache memory 816. In general, memory 806 can include any suitable volatile or non-volatile computer-readable storage media.

System administrator program 122, computer interface 124, database 126, server program 132, server interface 134, hardware components 136, and locking mechanism 138 are stored in persistent storage 808 for execution and/or access by one or more of the respective computer processors 804 via one or more memories of memory 806. In this embodiment, persistent storage 808 includes a magnetic hard disk drive. Alternatively, or in addition to a magnetic hard disk drive, persistent storage 808 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 808 may also be removable. For example, a removable hard drive may be used for persistent storage 808. Other examples include optical and magnetic disks, thumb drives, and smart cards that are inserted into a drive for transfer onto another computer-readable storage medium that is also part of persistent storage 808.

Communications unit 810, in these examples, provides for communications with other data processing systems or devices, including resources of network 110. In these examples, communications unit 810 includes one or more network interface cards. Communications unit 810 may provide communications through the use of either or both physical and wireless communications links. System administrator program 122, computer interface 124, database 126, server program 132, server interface 134, hardware components 136, and locking mechanism 138 may be downloaded to persistent storage 808 through communications unit 810.

I/O interface(s) 812 allows for input and output of data with other devices that may be connected to computer system 120, server system 130, technician device 140, automated service device 150. For example, I/O interface 812 may provide a connection to external devices 818 such as a keyboard, keypad, a touch screen, and/or some other suitable input device. External devices 818 can also include portable computer-readable storage media such as, for example, thumb drives, portable optical or magnetic disks, and memory cards. Software and data used to practice embodiments of the present invention, e.g., system administrator program 122, computer interface 124, database 126, server program 132, server interface 134, and hardware components 136, can be stored on such portable computer-readable storage media and can be loaded onto persistent storage 808 via I/O interface(s) 812. I/O interface(s) 812 also connect to a display 820.

Display 820 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) such as, for example, “Smalltalk” and the like may be subject to trademark rights in various jurisdictions throughout the world and are used here only in reference to the products or services properly denominated by the marks to the extent that such trademark rights may exist.

What is claimed is:

1. A computer-implemented method comprising:
scheduling, by one or more processors, a hardware service event for a hardware component, the hardware component locked in a physically locked position by a locking mechanism of a hardware lock;
at a time corresponding to the hardware service event, authorizing, by one or more processors, a service technician to access the hardware component;
instructing, by one or more processors, the hardware lock to disengage the locking mechanism based, at least in part, on the authorizing of the service technician;
determining, by one or more processors, that an end condition for the hardware service event has been met; and
terminating, by one or more processors, the hardware service event based, at least in part, on the determining that the end condition for the hardware service event has been met.

2. The computer-implemented method of claim 1, further comprising:
receiving, by one or more processors, a hardware alert relating to the hardware component, the hardware alert identifying a failure condition of the hardware component,
wherein the scheduling of the hardware service event is based, at least in part, on the received hardware alert.

3. The computer-implemented method of claim 1, further comprising:
determining, by one or more processors, a level of difficulty for performing hardware service during the hardware service event;
determining, by one or more processors, the service technician based, at least in part, on the determined level of difficulty; and
determining, by one or more processors, an availability of the service technicians,
wherein the scheduling of the hardware service event is based, at least in part, on the determined level of difficulty and the determined availability of the service technician.

4. The computer-implemented method of claim 1, wherein authorizing the service technician to access the hardware component includes authenticating the service technician using an authentication method selected from the group consisting of: (i) a biometric identifier, (ii) a radio frequency identification tag attached to a physical object, and (iii) a wireless hotspot connected to a device that communicates a password.

5. The computer-implemented method of claim 1, wherein determining that the end condition for the hardware service event has been met includes determining that the locking mechanism has been manually reengaged.

6. The computer-implemented method of claim 1, wherein determining that the end condition for the hardware service event has been met includes determining that an amount of time for the hardware service event has elapsed.

7. The computer-implemented method of claim 1, wherein terminating the hardware service event includes instructing the hardware lock to prevent manual disengagement of the locking mechanism.

8. The computer-implemented method of claim 1, wherein the hardware component is a computer drive and the hardware lock is mounted adjacent to a drive slot of a drive carrier in which the computer drive is stored.

9. A computer program product, the computer program product comprising:
one or more computer-readable storage media and program instructions stored on the one or more computer-readable storage media, the stored program instructions comprising:
program instructions to schedule a hardware service event for a hardware component, the hardware component locked in a physically locked position by a locking mechanism of a hardware lock;
program instructions to, at a time corresponding to the hardware service event, authorize a service technician to access the hardware component;
program instructions to instruct the hardware lock to disengage the locking mechanism based, at least in part, on the authorizing of the service technician;
program instructions to determine that an end condition for the hardware service event has been met; and
program instructions to terminate the hardware service event based, at least in part, on the determining that the end condition for the hardware service event has been met.

10. The computer program product of claim 9, wherein authorizing the service technician to access the hardware component includes authenticating the service technician using an authentication method selected from the group consisting of: (i) a biometric identifier, (ii) a radio frequency identification tag attached to a physical object, and (iii) a wireless hotspot connected to a device that communicates a password.

11. The computer program product of claim 9, wherein determining that the end condition for the hardware service event has been met includes determining that the locking mechanism has been manually reengaged.

12. The computer program product of claim 9, wherein determining that the end condition for the hardware service event has been met includes determining that an amount of time for the hardware service event has elapsed.

13. The computer program product of claim 9, wherein terminating the hardware service event includes instructing the hardware lock to prevent manual disengagement of the locking mechanism.

14. The computer program product of claim 9, wherein the hardware component is a computer drive and the hardware lock is mounted adjacent to a drive slot of a drive carrier in which the computer drive is stored.

15. A computer system, the computer system comprising:
one or more computer processors;
one or more computer readable storage medium; and
program instructions stored on the one or more computer readable storage medium for execution by at least one of the one or more processors, the stored program instructions comprising:
program instructions to schedule a hardware service event for a hardware component, the hardware component locked in a physically locked position by a locking mechanism of a hardware lock;
program instructions to, at a time corresponding to the hardware service event, authorize a service technician to access the hardware component;
program instructions to instruct the hardware lock to disengage the locking mechanism based, at least in part, on the authorizing of the service technician;
program instructions to determine that an end condition for the hardware service event has been met; and
program instructions to terminate the hardware service event based, at least in part, on the determining that the end condition for the hardware service event has been met.

16. The computer system of claim 15, wherein authorizing the service technician to access the hardware component includes authenticating the service technician using an authentication method selected from the group consisting of: (i) a biometric identifier, (ii) a radio frequency identification tag attached to a physical object, and (iii) a wireless hotspot connected to a device that communicates a password.

17. The computer system of claim 15, wherein determining that the end condition for the hardware service event has been met includes determining that the locking mechanism has been manually reengaged.

18. The computer system of claim 15, wherein determining that the end condition for the hardware service event has been met includes determining that an amount of time for the hardware service event has elapsed.

19. The computer system of claim 15, wherein terminating the hardware service event includes instructing the hardware lock to prevent manual disengagement of the locking mechanism.

20. The computer system of claim 15, wherein the hardware component is a computer drive and the hardware lock is mounted adjacent to a drive slot of a drive carrier in which the computer drive is stored.
